(19) United States
(12) Patent Application Publication
(10) Pub. No.: US 2024/0414773 A1
(43) Pub. Date: Dec. 12, 2024

(54) METHOD, DEVICE AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/705,157

(22) PCT Filed: Oct. 27, 2021
(86) PCT No.: PCT/CN2021/126820

§ 371 Date: Apr. 26, 2024

(51) Int. Cl. H04W 74/0833; H04W 24/08; H04W 74/00; H04W 76/20

(52) U.S. Cl. CPC H04W 74/0833; H04W 24/08; H04W 74/006; H04W 76/20

(57) ABSTRACT

Embodiments of the present disclosure relate to methods, devices and computer readable media for communication. According to embodiments of the present disclosure, a terminal device receives, from a network device, a first physical random access channel (PRACH) repetition pattern. The PRACH repetition pattern comprises a first list of resource sets. If none of power of the resource sets in the first PRACH repetition pattern exceeds a first power threshold, the terminal device determines whether power of at least one resource set in the first PRACH repetition pattern exceeds a second power threshold. The terminal device performs repetitions for at least one PRACH based on the determination. In this way, the PRACH repetition can be performed more sufficiently.

### TECHNICAL FIELD

Embodiments of the present disclosure generally relate to the field of telecommunication, and in particular, to methods, devices and computer storage media for communication.

### BACKGROUND

With development of communication systems, more and more technologies have been proposed. A physical random-access channel (PRACH) is a shared channel used by terminal devices to access the mobile network for cell set-up and burst data transmission. In order to improve a rate of successful transmissions, transmission repetition has been proposed.

### SUMMARY

In general, embodiments of the present disclosure provide methods, devices and computer storage media for communications.

In a first aspect, there is provided a method of communication. The method comprises: receiving, at a terminal device and from a network device, a first physical random access channel (PRACH) repetition pattern, wherein the first PRACH repetition pattern comprises a first list of resource sets; if none of power of the resource sets in the first PRACH repetition pattern exceeds a first power threshold, determining whether power of at least one resource set in the first PRACH repetition pattern exceeds a second power threshold; and performing repetitions for at least one PRACH based on the determination.

In a second aspect, there is provided a terminal device. The terminal device comprises a processor and a memory coupled to the processor. The memory stores instructions that when executed by the processor, cause the terminal device to perform: receiving, from a network device, a first physical random access channel (PRACH) repetition pattern, wherein the first PRACH repetition pattern comprises a first list of resource sets; if none of power of the resource sets in the first PRACH repetition pattern exceeds a first power threshold, determining whether power of at least one resource set in the first PRACH repetition pattern exceeds a second power threshold; and performing repetitions for at least one PRACH based on the determination.

In a third aspect, there is provided a computer readable medium having instructions stored thereon. The instructions, when executed on at least one processor, cause the at least one processor to perform the method according to the first aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications between devices in accordance with some embodiments of the present disclosure;

FIG. 3A shows a schematic diagram of PRACH occasions in accordance with some embodiments of the present disclosure;

FIG. 3B shows a schematic diagram of PRACH occasions in accordance with some embodiments of the present disclosure;

FIG. 4 shows a schematic diagram of a monitoring window in accordance with some embodiments of the present disclosure;

FIG. 5 illustrates a flow chart of an example method of communication implemented at a terminal device in accordance with some embodiments of the present disclosure;

FIG. 6 illustrates a flow chart of an example method of communication implemented at a network device in accordance with some embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Internet of Everything (Iowa) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (Node or NB), an Evolved Node (anode or eNB), a next generation Node (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As mentioned above, the terminal device may initiate the random access procedure to access the PRACH. Random Access Procedure (RACH) can be contention based (CBRA) or contention free (CFRA). PRACH enhancements have been studied from several aspects, including multiple PRACH transmissions with the same beam, multiple PRACH transmissions with different beams, and PRACH enhancements with finer beam.

Potential impacts of multiple PRACH transmissions may include: for multiple PRACH transmissions with the same transmission beam and multiple PRACH transmissions with different transmission beams, mechanism on triggering/initiating multiple PRACH transmissions, determination of number of transmissions and transmission pattern, differentiation between enhanced UE and legacy UE and possible collision handling between PRACH transmission with and without multiple PRACH transmissions. Only for multiple PRACH transmissions with different transmission beams, transmission beam to be used for each initial transmission and beam determination for the following steps in RACH procedure. Potential impacts of PRACH enhancements with finer beam may include: finer beam for PRACH based on CSI-RS resources configured during initial access.

In order to solve at least part of above problems, a new solution on PRACH repetition enhancement is needed. According to embodiments of the present disclosure, a terminal device receives, from a network device, a first PRACH repetition pattern. The PRACH repetition pattern comprises a first list of resource sets. If none of power of the resource sets in the first PRACH repetition pattern exceeds a first power threshold, the terminal device determines whether power of at least one resource set in the first PRACH repetition pattern exceeds a second power threshold. The terminal device performs repetitions for at least one PRACH based on the determination. In this way, the PRACH repetitions can be performed more sufficiently.

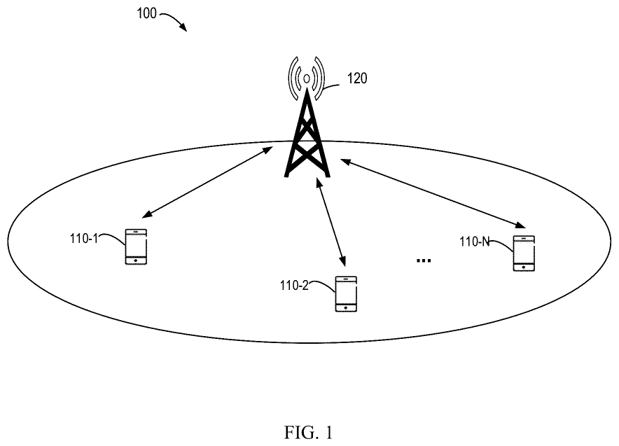

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device 120. In the communication system 100, the network devices 120 and the terminal devices 110 can communicate data and control information to each other. The numbers of devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios.

For example, embodiments of the present disclosure can be implemented at NR IIoT/URLLC. Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-Iota and LTE-MTC, Integrated Access and Backhaul (IAB), NR Multicast and Broadcast Services, or enhancements on Multi-Radio Dual-Connectivity.

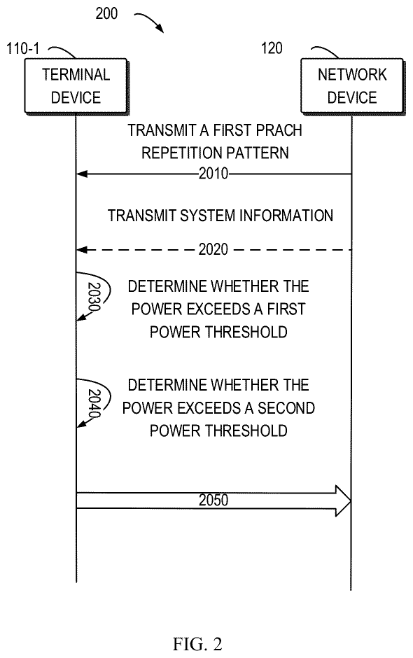

FIG. 2 shows a signaling chart illustrating process 200 among devices according to some example embodiments of the present disclosure. Only for the purpose of discussion, the process 200 will be described with reference to FIG. 1. The process 200 may involve the terminal device 110-1 and the network device 120 in FIG. 1. It should be noted that the process 200 is only an example not limitation.

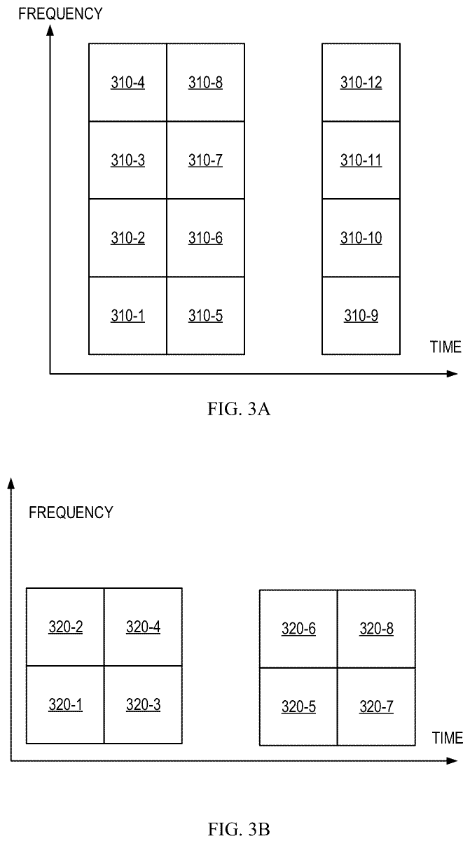

The network device 120 transmits 2010 a first PRACH repetition pattern to the terminal device 110-1. The first PRACH repetition pattern comprises a first list of resource sets. For example, the first PRACH repetition pattern may comprise a set of PRACH occasions for the PRACH repetition. Alternatively or in addition, the first PRACH repetition pattern can comprise a set of preambles for the PRACH repetition. The term “PRACH occasion” used herein can refer to a time and frequency domain resource where the terminal device is able to transmission a preamble. As shown in FIG. 3A, there are 12 PRACH occasions and the 12 PRACH occasions are associated with 2 beams. For example, the PRACH occasions 310-1, 310-3., 310-5, 310-7, 310-6 and 310-11 are on the first beam, the PRACH occasions 310-2, 310-4, 310-6, 310-8, 310-10 and 310-12 are on the second beam. As another embodiment, as shown in FIG. 3B, there are 8 PRACH occasions and the 8 PRACH occasions are associated with 4 beams. For example, the PRACH occasions 320-1 and 320-5 are on the first beam, the PRACH occasions 320-2 and 320-6 are on the second beam, the PRACH occasions 320-3 and 320-7 are on the third beam, and the PRACH occasions 320-4 and 320-8 are on the fourth beam.

In some embodiments, the network device 120 can transmit a RRC configuration to the terminal device 110-1. The RRC configuration can indicate a first threshold power. The first threshold power can be a reference signal received power (RSRP) threshold, for example, rsrp-ThresholdSSB. In this way, it can save signaling overhead. It should be noted that the first threshold power can be any proper threshold power. The term “rsrp-ThresholdSSB” used herein can refer to a RSRP threshold for the selection of the synchronization signal (SS)/physical broadcast channel (PBCH) block (SSB).

The network device 120 may transmit 2020 system information to the terminal device 110-1. The system information can indicate a second threshold power. For example, the second threshold power can be rsrp-ThresholdSSB-repetition. The second threshold power can be any suitable value. For example, the second threshold power can be smaller than the first threshold power.

The terminal device 110-1 determines 2030 whether a power of at least one resource set exceeds the first threshold power. In some embodiments, if the power of one or more resource sets is larger than the first threshold power, the terminal device 110-1 may perform a single transmission of the PRACH on the one or more resource sets. For example, if there is a SSB with SS-RSRP above the first power threshold, the terminal device 110-1 may select the SSB and perform the single transmission on the SSB.

If none of power of the resource sets in the first PRACH repetition pattern exceeds the first power threshold, the terminal device 110-1 determines 2040 whether the power of at least one resource set exceeds the second threshold power. The terminal device 110-1 performs 2050 repetitions for at least one PRACH based on the determination. Details of performing the PRACH repetition are described below.

In some embodiments, the resources for the PRACH repetition may be the same beam. In other words, the resources for the PRACH repetition may be associated with the same SS/PBCH block or channel state information-reference signal (CSI-RS) resource. In this case, if the power of the at least one resource set exceeds the second power threshold, the terminal device 110-1 may perform the PRACH repetition based on one of the at least one resource set. The terminal device 110-1 may select any resource set with the power above the second power threshold. Alternatively, the terminal device 110-1 may select the resource set with the best power. For example, if there is at least one SSB with SS-RSRP above rsrp-ThresholdSSB-repetition, the terminal device 110-1 may select an SSB or the best SSB with SS-RSRP above rsrp-ThresholdSSB-repetition for PRACH repetition.

In other embodiments, if none of power of the resource sets in the first PRACH repetition pattern exceeds the second power threshold, the terminal device 110-1 may perform the PRACH repetition based on one resource set in the first list of resource sets. For example, the terminal device 110-1 may select any resource set. Alternatively, the e terminal device 110-1 may select the resource set with the best power. For example, if there is no SSB with SS-RSRP above rsrp-ThresholdSSB-repetition, the terminal device 110-1 may select any SSB or the best SSB with SS-RSRP.

Alternatively, the resources for the PRACH repetition may be different beams. For example, the network device 120 may transmit a second PRACH repetition pattern. The second PRACH repletion may comprise a second list of resource sets. The first list of resource sets may be associated with a first beam and the second list of resource sets may be associated with a second beam. If none of power of the resource sets in the second PRACH repetition pattern exceeds the first power threshold, the terminal device 110-1 determines 2040 whether the power of at least one resource set in the second list of resource sets exceeds the second threshold power.

In the above case, in some embodiments, if power of all resource sets in the first PRACH repetition exceed the second power threshold and power of the at least one resource set in the second PRACH repetition pattern is below the second power threshold, the terminal device 110-1 may perform the PRACH repetition based on the first PRACH pattern. Alternatively, power of all resource sets in the first PRACH repetition exceed the second power threshold and power of all resource sets in the second PRACH repetition pattern exceeds the second power threshold, the terminal device 110-1 may perform the PRACH repetition based on the first PRACH pattern or the second PRACH pattern. For example, if all SSBs with SS-RSRP above rsrp-ThresholdSSB-repetition in at least one of PRACH repetition pattern are available, the terminal device 110-1 may select a satisfied PRACH repetition pattern. Otherwise, the terminal device 110-1 may select any PRACH pattern.

In some embodiments, if the power of the at least one resource set in the first PRACH repetition pattern is below the second power threshold and the power of the at least one resource set in the second PRACH repetition pattern is below the second power threshold, the terminal device 110-1 may perform the PRACH repetition based on the first PRACH pattern or the second PRACH pattern. Alternatively, if the power of the at least one resource set in the first PRACH repetition pattern exceeds the second power threshold and none of power of the resource sets in the second PRACH repetition pattern exceeds the second power threshold, the terminal device 110-1 may perform the PRACH repetition on the first beam based on the first PRACH pattern. In other embodiments, if the power of the at least one resource set in the first PRACH repetition pattern exceeds the second power threshold and the power of the at least one resource set in the second PRACH repetition pattern exceeds the second power threshold, the terminal device 110-1 may perform the PRACH repetition based on the first PRACH pattern or the second PRACH pattern. In some other embodiments, if none of power of the resource sets in the first PRACH repetition pattern exceeds the second power threshold and none of power of the resource sets in the second PRACH repetition pattern exceeds the second power threshold, the terminal device 110-1 may perform the PRACH repetition based on one of: the first PRACH repetition pattern or the second PRACH repetition pattern. For example, if at least one of SSBs with SS-RSRP above rsrp-ThresholdSSB-repetition in at least one of PRACH repetition pattern is available, the terminal device 110-1 may select a satisfied PRACH repetition pattern. Otherwise, the terminal device 110-1 may select any PRACH pattern.

In other embodiments, if average power of all resource sets in the first PRACH repetition pattern exceeds the second power threshold and average power of all resource sets in the second PRACH repetition pattern is below the second power threshold, the terminal device 110-1 may perform the PRACH repetition on the first beam based on the first PRACH repetition pattern. Alternatively, if the average power of all resource sets in the first PRACH repetition pattern exceeds the second power threshold and average power of all resource sets in the second PRACH repetition pattern exceeds the second power threshold, the terminal device 110-1 may perform the PRACH repetition based on one of: the first PRACH repetition pattern or the second PRACH repetition pattern. In other embodiments, if average power of all resource sets in the first PRACH repetition pattern is below the second power threshold and average power of all resource sets in the second PRACH repetition pattern is below the second power threshold, the terminal device 110-1 may perform the PRACH repetition based on one of: the first PRACH repetition pattern or the second PRACH repetition pattern. For example, if average SS-RSRP for all SSBs in at least one of PRACH repetition pattern above rsrp-ThresholdSSB-repetition is available, the terminal device 110-1 may select a satisfied PRACH repetition pattern. Otherworse, the terminal device 110-1 may select any PRACH pattern.

In some embodiments, the PRACH repetitions can be configured for normal uplink (NUL) and supplementary uplink (SUL). In this case, the terminal device 110-1 may determine to perform the PRACH repetitions on the NUL or SUL based on a third power threshold. If the RSRP at the terminal device 110-1 is larger than the third power threshold, the terminal device 110-1 may determine to perform the PRACH on the NUL. In this case, the terminal device 110-1 may then determine whether to perform the PRACH repetitions based on the first power threshold. If the RSRP exceeds the first power threshold, the terminal device 110-1 may perform the single transmission of the PRACH. Alternatively, if the RSRP is below the first power threshold, the terminal device 110-1 may perform the PRACH repetitions. In some embodiments, both the first power threshold and the second power threshold may be larger than the third power threshold.

The network device 120 may configure separate preambles and/or PRACH occasions to the terminal device supporting PRACH repetition. The network device 120 may configure PRACH repetition resource lists to the terminal device 110-1. Entries in the list may comprise a set of PRACH occasions and preambles that the terminal device 110-1 can transmit. For example, the first list of resource sets can comprise a first set of PRACH occasions and a first set of preambles. The second list of resource sets may comprise a second set of PRACH occasions and a second set of preambles. In this way, the network device 120 can distinguish different UE types. Further, the system performance can be improved by avoiding collisions.

In some embodiments, the first PRACH repetition pattern may indicate: the maximum number of repetitions N, a preamble M, a starting PRACH occasion S and a delta D. In this case, the terminal device 110-1 may transmit the preamble M on each PRACH occasion S+i×D, where i can be from 0 to N−1. For example, as shown in FIG. 3A, the number of repetitions N is 2, the starting PRACH occasion S is 1 and the delta D is 4. In this case, the PRACH occasions for the PRACH transmission can be PRACH occasion 310-1 and PRACH occasion 310-5. Alternatively, as shown in FIG. 3B, the number of repetitions N is 2, the starting PRACH occasion S is 2 and the delta D is 4. In this case, the PRACH occasions for the PRACH transmission can be PRACH occasion 320-2 and PRACH occasion 320-6.

Alternatively, time period parameter and additional frequency hopping parameter may be configured in the first PRACH repetition pattern. The terminal device 110-1 may transmit PRACH based on time period, from the starting PRACH occasion and repetition on every period PRACH occasion until the end of repetition. Additional frequency hopping may be configured for the terminal device 110-1 to select PRACH occasion in one time occasion if there are more than one PRACH occasion with the same beam (selected by the terminal device as for a SS/PBCH block or a CSI-RS resource) on different frequency resources and the same time resources. In some embodiments, additional frequency hopping can be a value Hop configure by network, the terminal device can select the k-th PO in frequency domain in time t and select the (k+Hop)-th PO in frequency domain in time t+1. For example, as shown in FIG. 3A, the PRACH repetition in time and hopping in frequency lead to PRACH transmission on the PRACH occasions 320-1 and 320-7.

In other embodiments, the first PRACH repetition pattern may indicate that preamble hopping may be configured for PRACH repetition. In this case, the terminal device 110-1 may select different preamble index in different PO when PRACH repetition is applied. For example, the terminal device 110-1 may select preamble 3 in the PRACH occasion 310-1 and preamble 7 in the PRACH occasion 310-5 for PRACH repetition. Preamble hopping has benefit to randomize interference of different preamble in a cell. When two different terminal devices select nearby preamble which has larger interference in one PO, they may select not nearby preamble in next PRACH occasion due to preamble hopping.

In some embodiments, the terminal device 110-1 may keep transmission power consistent during PRACH repetition. In other words, there may be no power ramping between each PRACH transmission, as the network device 120 may combine repetition firstly then detect presence of preamble in which case transmission power ramping is harmful for network detection.

In other embodiments, the terminal device 110-1 may detect downlink control information (DCI) in a first random access response monitoring window. The terminal device 110-1 may perform the PRACH repetition based on a transmission code index (TCI) state associated with the random access response monitoring window. The length of the random access response monitoring window may be configured by the network device 120. For example, if the terminal device 110-1 detects a DCI format 1_0 in a slot located in the n-th RAR monitoring window with cyclic redundancy check (CRC) scrambled by the corresponding random access radio network temporary identifier (RA-RNTI) and least significant bits (LSBs) of a system frame number (SFN) field in the DCI format 10, if included and applicable, are same as corresponding LSBs of the SFN where the terminal device 110-1 transmitted the PRACH, and the terminal device 110-1 receives a transport block in a corresponding PDSCH, the terminal device 110-1 may assume same demodulation reference signal (DM-RS) antenna port quasi co-location properties, as for a SS/PBCH block or a CSI-RS resource the terminal device 110-1 used for PRACH association transmitted in the n-th repetition, regardless of whether or not the terminal device 110-1 is provided TCI State for the CORESET where the UE receives the PDCCH with the DCI format 1_0.

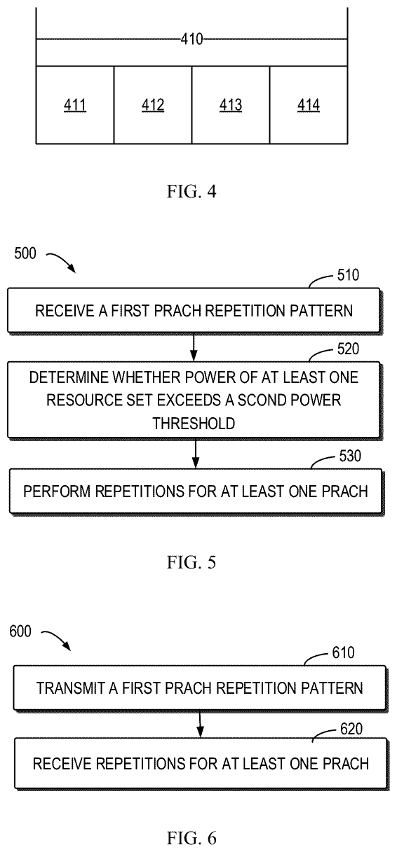

For example, as shown in FIG. 4, there are 4 PRACH repetitions in the random access monitoring window 410. If the terminal device 110-1 select the PRACH occasions 320-1 and 320-3 for PRACH repetitions, the terminal device 110-1 may assume QCL with the PRACH occasion 320-1 for the PRACH repetitions 411 and 413. The terminal device 110-1 may assume QCL with the PRACH occasion 320-3 for the PRACH repetitions 412 and 414.

Alternatively, the terminal device 110-1 may detect downlink control information on a control resource set. For example, the terminal device 110-1 may detect the downlink control information on CORESET #0. The CORESET may indicate a first TCI state. In this case, the terminal device 110-1 may perform the PRACH repetition based on the first TCI state. If the terminal device 110-1 monitors random access response (RAR) DCI on CORESET, the terminal device 110-1 can assume QCL properties for Type-1 UE-specific search space (USS) same as Type-0 USS. For example, if the terminal device 110-1 detects a DCI format 1_0 with CRC scrambled by the corresponding RA-RNTI and LSBs of a SFN field in the DCI format 1_0, if included and applicable, are same as corresponding LSBs of the SFN where the UE transmitted the PRACH, and the terminal device 110-1 receives a transport block in a corresponding PDSCH, the terminal device 110-1 may assume same DM-RS antenna port quasi co-location properties as provided TCI State for the CORESET where the UE receives the PDCCH with the DCI format 1_0.

FIG. 5 shows a flowchart of an example method 500 in accordance with an embodiment of the present disclosure. Only for the purpose of illustrations, the method 500 can be implemented at a terminal device 110-1 as shown in FIG. 1.

At block 510, the terminal device 110-1 receives a first PRACH repetition pattern from the network device 120. The first PRACH repetition pattern comprises a first list of resource sets. For example, the first PRACH repetition pattern may comprise a set of PRACH occasions for the PRACH repetition. Alternatively or in addition, the first PRACH repetition pattern can comprise a set of preambles for the PRACH repetition. The term “PRACH occasion” used herein can refer to a time and frequency domain resource where the terminal device is able to transmission a preamble.

In some embodiments, the terminal device 110-1 can receive a RRC configuration from the network device 120. The RRC configuration can indicate a first threshold power. The first threshold power can be a reference signal received power (RSRP) threshold, for example, rsrp-ThresholdSSB. In this way, it can save signaling overhead. It should be noted that the first threshold power can be any proper threshold power. The term “rsrp-ThresholdSSB” used herein can refer to a RSRP threshold for the selection of the synchronization signal (SS)/physical broadcast channel (PBCH) block (SSB).

The terminal device 110-1 can receive system information from the network device 120. The system information can indicate a second threshold power. For example, the second threshold power can be rsrp-ThresholdSSB-repetition. The second threshold power can be any suitable value. For example, the second threshold power can be smaller than the first threshold power.

The terminal device 110-1 determines whether a power of at least one resource set exceeds the first threshold power. In some embodiments, if the power of one or more resource sets is larger than the first threshold power, the terminal device 110-1 may perform a single transmission of the PRACH on the one or more resource sets. For example, if there is a SSB with SS-RSRP above the first power threshold, the terminal device 110-1 may select the SSB and perform the single transmission on the SSB.

At block 520, if none of power of the resource sets in the first PRACH repetition pattern exceeds the first power threshold, the terminal device 110-1 determines whether the power of at least one resource set exceeds the second threshold power.

At block 530, the terminal device 110-1 performs repetitions for at least one PRACH based on the determination. Details of performing the PRACH repetition are described below. In some embodiments, the resources for the PRACH repetition may be the same beam. In other words, the resources for the PRACH repetition may be associated with the same SS/PBCH block or channel state information-reference signal (CSI-RS) resource. In this case, if the power of the at least one resource set exceeds the second power threshold, the terminal device 110-1 may perform the PRACH repetition based on one of the at least one resource set. The terminal device 110-1 may select any resource set with the power above the second power threshold. Alternatively, the terminal device 110-1 may select the resource set with the best power. For example, if there is at least one SSB with SS-RSRP above rsrp-ThresholdSSB-repetition, the terminal device 110-1 may select an SSB or the best SSB with SS-RSRP above rsrp-ThresholdSSB-repetition for PRACH repetition.

In other embodiments, if none of power of the resource sets in the first PRACH repetition pattern exceeds the second power threshold, the terminal device 110-1 may perform the PRACH repetition based on one resource set in the first list of resource sets. For example, the terminal device 110-1 may select any resource set. Alternatively, the e terminal device 110-1 may select the resource set with the best power. For example, if there is no SSB with SS-RSRP above rsrp-ThresholdSSB-repetition, the terminal device 110-1 may select any SSB or the best SSB with SS-RSRP.

Alternatively, the resources for the PRACH repetition may be different beams. For example, the network device 120 may transmit a second PRACH repetition pattern. The second PRACH repletion may comprise a second list of resource sets. The first list of resource sets may be associated with a first beam and the second list of resource sets may be associated with a second beam. If none of power of the resource sets in the second PRACH repetition pattern exceeds the first power threshold, the terminal device 110-1 determines 2040 whether the power of at least one resource set in the second list of resource sets exceeds the second threshold power.

In the above case, in some embodiments, if power of all resource sets in the first PRACH repetition exceed the second power threshold and power of the at least one resource set in the second PRACH repetition pattern is below the second power threshold, the terminal device 110-1 may perform the PRACH repetition based on the first PRACH pattern. Alternatively, power of all resource sets in the first PRACH repetition exceed the second power threshold and power of all resource sets in the second PRACH repetition pattern exceeds the second power threshold, the terminal device 110-1 may perform the PRACH repetition based on the first PRACH pattern or the second PRACH pattern. For example, if all SSBs with SS-RSRP above rsrp-ThresholdSSB-repetition in at least one of PRACH repetition pattern are available, the terminal device 110-1 may select a satisfied PRACH repetition pattern. Otherwise, the terminal device 110-1 may select any PRACH pattern.

In some embodiments, if the power of the at least one resource set in the first PRACH repetition pattern is below the second power threshold and the power of the at least one resource set in the second PRACH repetition pattern is below the second power threshold, the terminal device 110-1 may perform the PRACH repetition based on the first PRACH pattern or the second PRACH pattern. Alternatively, if the power of the at least one resource set in the first PRACH repetition pattern exceeds the second power threshold and none of power of the resource sets in the second PRACH repetition pattern exceeds the second power threshold, the terminal device 110-1 may perform the PRACH repetition on the first beam based on the first PRACH pattern. In other embodiments, if the power of the at least one resource set in the first PRACH repetition pattern exceeds the second power threshold and the power of the at least one resource set in the second PRACH repetition pattern exceeds the second power threshold, the terminal device 110-1 may perform the PRACH repetition based on the first PRACH pattern or the second PRACH pattern. In some other embodiments, if none of power of the resource sets in the first PRACH repetition pattern exceeds the second power threshold and none of power of the resource sets in the second PRACH repetition pattern exceeds the second power threshold, the terminal device 110-1 may perform the PRACH repetition based on one of: the first PRACH repetition pattern or the second PRACH repetition pattern. For example, if at least one of SSBs with SS-RSRP above rsrp-ThresholdSSB-repetition in at least one of PRACH repetition pattern is available, the terminal device 110-1 may select a satisfied PRACH repetition pattern. Otherwise, the terminal device 110-1 may select any PRACH pattern.

In other embodiments, if average power of all resource sets in the first PRACH repetition pattern exceeds the second power threshold and average power of all resource sets in the second PRACH repetition pattern is below the second power threshold, the terminal device 110-1 may perform the PRACH repetition on the first beam based on the first PRACH repetition pattern. Alternatively, if the average power of all resource sets in the first PRACH repetition pattern exceeds the second power threshold and average power of all resource sets in the second PRACH repetition pattern exceeds the second power threshold, the terminal device 110-1 may perform the PRACH repetition based on one of: the first PRACH repetition pattern or the second PRACH repetition pattern. In other embodiments, if average power of all resource sets in the first PRACH repetition pattern is below the second power threshold and average power of all resource sets in the second PRACH repetition pattern is below the second power threshold, the terminal device 110-1 may perform the PRACH repetition based on one of: the first PRACH repetition pattern or the second PRACH repetition pattern. For example, if average SS-RSRP for all SSBs in at least one of PRACH repetition pattern above rsrp-ThresholdSSB-repetition is available, the terminal device 110-1 may select a satisfied PRACH repetition pattern. Otherwise, the terminal device 110-1 may select any PRACH pattern.

In some embodiments, the PRACH repetitions can be configured for normal uplink (NUL) and supplementary uplink (SUL). In this case, the terminal device 110-1 may determine to perform the PRACH repetitions on the NUL or SUL based on a third power threshold. If the RSRP at the terminal device 110-1 is larger than the third power threshold, the terminal device 110-1 may determine to perform the PRACH on the NUL. In this case, the terminal device 110-1 may then determine whether to perform the PRACH repetitions based on the first power threshold. If the RSRP exceeds the first power threshold, the terminal device 110-1 may perform the single transmission of the PRACH. Alternatively, if the RSRP is below the first power threshold, the terminal device 110-1 may perform the PRACH repetitions. In some embodiments, both the first power threshold and the second power threshold may be larger than the third power threshold.

The network device 120 may configure separate preamble and/or PRACH occasion to the terminal device supporting PRACH repetition. The network device 120 may configure PRACH repetition resource lists to the terminal device 110-1. Entries in the list may comprise a set of PRACH occasions and preambles that the terminal device 110-1 can transmit. For example, the first list of resource sets can comprise a first set of PRACH occasions and a first set of preambles. The second list of resource sets may comprise a second set of PRACH occasions and a second set of preambles. In this way, the network device 120 can distinguish different UE types. Further, the system performance can be improved by avoiding collisions.

In some embodiments, the first PRACH repetition pattern may indicate: the maximum number of repetitions N, a preamble M, a starting PRACH occasion S and a delta D. In this case, the terminal device 110-1 may transmit the preamble M on each PRACH occasion S+i×D, where i can be from 0 to N−1.

Alternatively, time period parameter and additional frequency hopping parameter may be configured in the first PRACH repetition pattern. The terminal device 110-1 may transmit PRACH based on time period, from the starting PRACH occasion and repetition on every period PRACH occasion until the end of repetition. Additional frequency hopping may be configured for the terminal device 110-1 to select PRACH occasion in one time occasion if there are more than one PRACH occasion with the same beam (selected by the terminal device as for a SS/PBCH block or a CSI-RS resource) on different frequency resources and the same time resources. In some embodiments, additional frequency hopping can be a value Hop configure by network, the terminal device can select the k-th PO in frequency domain in time t and select the (k+Hop)-th PO in frequency domain in time t+1.

In other embodiments, the first PRACH repetition pattern may indicate that preamble hopping may be configured for PRACH repetition. In this case, the terminal device 110-1 may select different preamble index in different PO when PRACH repetition is applied.

In some embodiments, the terminal device 110-1 may keep transmission power consistent during PRACH repetition. In other words, there may be no power ramping between each PRACH transmission, as the network device 120 may combine repetition firstly then detect presence of preamble in which case transmission power ramping is harmful for network detection.

In other embodiments, the terminal device 110-1 may detect downlink control information (DCI) in a first random access response monitoring window. The terminal device 110-1 may perform the PRACH repetition based on a transmission code index (TCI) state associated with the random access response monitoring window. The length of the random access response monitoring window may be configured by the network device 120. For example, if the terminal device 110-1 detects a DCI format 1_0 in a slot located in the n-th RAR monitoring window with cyclic redundancy check (CRC) scrambled by the corresponding random access radio network temporary identifier (RA-RNTI) and least significant bits (LSBs) of a system frame number (SFN) field in the DCI format 10, if included and applicable, are same as corresponding LSBs of the SFN where the terminal device 110-1 transmitted the PRACH, and the terminal device 110-1 receives a transport block in a corresponding PDSCH, the terminal device 110-1 may assume same demodulation reference signal (DM-RS) antenna port quasi co-location properties, as for a SS/PBCH block or a CSI-RS resource the terminal device 110-1 used for PRACH association transmitted in the n-th repetition, regardless of whether or not the terminal device 110-1 is provided TCI State for the CORESET where the UE receives the PDCCH with the DCI format 1_0.

Alternatively, the terminal device 110-1 may detect downlink control information on a control resource set (CORESET) #0. The CORESET #0 may indicate a first TCI state. In this case, the terminal device 110-1 may perform the PRACH repetition based on the first TCI state. If the terminal device 110-1 monitors random access response (RAR) DCI on CORESET #0, the terminal device 110-1 can assume QCL properties for Type-1 UE-specific search space (USS) same as Type-0 USS. For example, if the terminal device 110-1 detects a DCI format 1_0 with CRC scrambled by the corresponding RA-RNTI and LSBs of a SFN field in the DCI format 1_0, if included and applicable, are same as corresponding LSBs of the SFN where the UE transmitted the PRACH, and the terminal device 110-1 receives a transport block in a corresponding PDSCH, the terminal device 110-1 may assume same DM-RS antenna port quasi co-location properties as provided TCI State for the CORESET where the UE receives the PDCCH with the DCI format 1_0.

FIG. 6 shows a flowchart of an example method 600 in accordance with an embodiment of the present disclosure. Only for the purpose of illustrations, the method 500 can be implemented at a network device 120 as shown in FIG. 1.

At block 610, the network device 120 transmits a first PRACH repetition pattern to the terminal device 110-1. The first PRACH repetition pattern comprises a first list of resource sets. For example, the first PRACH repetition pattern may comprise a set of PRACH occasions for the PRACH repetition. Alternatively or in addition, the first PRACH repetition pattern can comprise a set of preambles for the PRACH repetition. The term “PRACH occasion” used herein can refer to a time and frequency domain resource where the terminal device is able to transmission a preamble. As shown in FIG. 3A, there are 12 PRACH occasions and the 12 PRACH occasions are associated with 2 beams. For example, the PRACH occasions 310-1, 310-3., 310-5, 310-7, 310-6 and 310-11 are on the first beam, the PRACH occasions 310-2, 310-4, 310-6, 310-8, 310-10 and 310-12 are on the second beam. As another embodiment, as shown in FIG. 3B, there are 8 PRACH occasions and the 8 PRACH occasions are associated with 4 beams. For example, the PRACH occasions 320-1 and 320-5 are on the first beam, the PRACH occasions 320-2 and 320-6 are on the second beam, the PRACH occasions 320-3 and 320-7 are on the third beam, and the PRACH occasions 320-4 and 320-8 are on the fourth beam.

In some embodiments, the network device 120 can transmit a RRC configuration to the terminal device 110-1. The RRC configuration can indicate a first threshold power. The first threshold power can be a reference signal received power (RSRP) threshold, for example, rsrp-ThresholdSSB. In this way, it can save signaling overhead. It should be noted that the first threshold power can be any proper threshold power. The term “rsrp-ThresholdSSB” used herein can refer to a RSRP threshold for the selection of the synchronization signal (SS)/physical broadcast channel (PBCH) block (SSB).

The network device 120 may transmit system information to the terminal device 110-1. The system information can indicate a second threshold power. For example, the second threshold power can be rsrp-ThresholdSSB-repetition. The second threshold power can be any suitable value. For example, the second threshold power can be smaller than the first threshold power.

In some embodiments, the resources for the PRACH repetition may be the same beam. In other words, the resources for the PRACH repetition may be associated with the same SS/PBCH block or channel state information-reference signal (CSI-RS) resource.

Alternatively, the resources for the PRACH repetition may be different beams. For example, the network device 120 may transmit a second PRACH repetition pattern. The second PRACH repletion may comprise a second list of resource sets. The first list of resource sets may be associated with a first beam and the second list of resource sets may be associated with a second beam.

In some embodiments, the PRACH repetitions can be configured for normal uplink (NUL) and supplementary uplink (SUL). In this case, the terminal device 110-1 may determine to perform the PRACH repetitions on the NUL or SUL based on a third power threshold. If the RSRP at the terminal device 110-1 is larger than the third power threshold, the terminal device 110-1 may determine to perform the PRACH on the NUL. In this case, the terminal device 110-1 may then determine whether to perform the PRACH repetitions based on the first power threshold. If the RSRP exceeds the first power threshold, the terminal device 110-1 may perform the single transmission of the PRACH. Alternatively, if the RSRP is below the first power threshold, the terminal device 110-1 may perform the PRACH repetitions. In some embodiments, both the first power threshold and the second power threshold may be larger than the third power threshold.

The network device 120 may configure separate preamble and/or PRACH occasion to the terminal device supporting PRACH repetition. The network device 120 may configure PRACH repetition resource lists to the terminal device 110-1. Entries in the list may comprise a set of PRACH occasions and preambles that the terminal device 110-1 can transmit. For example, the first list of resource sets can comprise a first set of PRACH occasions and a first set of preambles. The second list of resource sets may comprise a second set of PRACH occasions and a second set of preambles. In this way, the network device 120 can distinguish different UE types. Further, the system performance can be improved by avoiding collisions.

In some embodiments, the first PRACH repetition pattern may indicate: the maximum number of repetitions N, a preamble M, a starting PRACH occasion S and a delta D. In this case, the terminal device 110-1 may transmit the preamble M on each PRACH occasion S+i×D, where i can be from 0 to N−1.

At block 620, the network device 120 receives the PRACH repetition based on the first PRACH repetition pattern.

In some embodiments, a terminal device comprises circuitry configured to receive, from a network device, a first physical random access channel (PRACH) repetition pattern, wherein the first PRACH repetition pattern comprises a first list of resource sets; if none of power of the resource sets in the first PRACH repetition pattern exceeds a first power threshold, determine whether power of at least one resource set in the first PRACH repetition pattern exceeds a second power threshold; and perform repetitions for at least one PRACH based on the determination.

In some embodiments, the terminal device comprises circuitry configured to perform the repetitions for the at least one PRACH by: in accordance with a determination that the power of the at least one resource set exceeds the second power threshold, performing the repetitions for the at least one PRACH based on one of the at least one resource set.

In some embodiments, the terminal device comprises circuitry configured to perform the repetitions for the at least one PRACH by: the repetitions for the at least one PRACH by: in accordance with a determination that none of power of the resource sets in the first PRACH repetition pattern exceeds the second power threshold, performing the repetitions for the at least one PRACH based on one resource set in the first list of resource sets.

In some embodiments, the terminal device comprises circuitry configured to receive, from the network device, a second PRACH repetition pattern, wherein the second PRACH repetition pattern comprises a second list of resource sets, and the first list of resource set is associated with a first beam and the second list of resource set is associated with a second beam.

In some embodiments, the terminal device comprises circuitry configured to if none of power of the resource sets in the second PRACH repetition pattern exceeds the first power threshold, determine whether power of at least one resource set in the second PRACH repetition pattern exceeds the second power threshold.

In some embodiments, the terminal device comprises circuitry configured to perform the repetitions for the at least one PRACH by: in accordance with a determination that power of all resource sets in the first PRACH repetition pattern exceed the second power threshold and a determination that power of the at least one resource set in the second PRACH repetition pattern is below the second power threshold, performing the repetitions for the at least one PRACH on the first beam based on the first PRACH pattern.

In some embodiments, the terminal device comprises circuitry configured to perform the repetitions for the at least one PRACH by: in accordance with a determination that power of all resource sets in the first PRACH repetition pattern exceed the second power threshold and a determination that power of all resource sets in the second PRACH repetition pattern exceeds the second power threshold, performing the repetitions for the at least one PRACH based on one of: the first PRACH repetition pattern or the second PRACH repetition pattern.

In some embodiments, the terminal device comprises circuitry configured to perform the repetitions for the at least one PRACH by: in accordance with a determination that the power of the at least one resource set in the first PRACH repetition pattern is below the second power threshold and a determination that the power of the at least one resource set in the second PRACH repetition pattern is below the second power threshold, performing the repetitions for the at least one PRACH based on one of the first PRACH repetition pattern or the second PRACH repetition pattern.

In some embodiments, the terminal device comprises circuitry configured to perform the repetitions for the at least one PRACH by: in accordance with a determination that the power of the at least one resource set in the first PRACH repetition pattern exceeds the second power threshold and a determination that none of power of the resource sets in the second PRACH repetition pattern exceeds the second power threshold, performing the repetitions for the at least one PRACH on the first beam based on the first PRACH pattern.

In some embodiments, the terminal device comprises circuitry configured to in accordance with a determination that the power of the at least one resource set in the first PRACH repetition pattern exceeds the second power threshold and a determination that the power of the at least one resource set in the second PRACH repetition pattern exceeds the second power threshold, perform the repetitions for the at least one PRACH based on one of: the first PRACH repetition pattern or the second PRACH repetition pattern.

In some embodiments, the terminal device comprises circuitry configured to in accordance with a determination that none of power of the resource sets in the first PRACH repetition pattern exceeds the second power threshold and a determination that none of power of the resource sets in the second PRACH repetition pattern exceeds the second power threshold, perform the repetitions for the at least one PRACH based on one of: the first PRACH repetition pattern or the second PRACH repetition pattern.

In some embodiments, the terminal device comprises circuitry configured to perform the repetitions for the at least one PRACH by: in accordance with a determination that average power of all resource sets in the first PRACH repetition pattern exceeds the second power threshold and a determination that average power of all resource sets in the second PRACH repetition pattern is below the second power threshold, performing the repetitions for the at least one PRACH on the first beam based on the first PRACH repetition pattern.

In some embodiments, the terminal device comprises circuitry configured to in accordance with a determination that average power of all resource sets in the first PRACH repetition pattern exceeds the second power threshold and a determination that average power of all resource sets in the second PRACH repetition pattern exceeds the second power threshold, perform the repetitions for the at least one PRACH based on one of: the first PRACH repetition pattern or the second PRACH repetition pattern.

In some embodiments, the terminal device comprises circuitry configured to perform the repetitions for the at least one PRACH by: in accordance with a determination that average power of all resource sets in the first PRACH repetition pattern is below the second power threshold and a determination that average power of all resource sets in the second PRACH repetition pattern is below the second power threshold, performing the repetitions for the at least one PRACH based on one of: the first PRACH repetition pattern or the second PRACH repetition pattern.

In some embodiments, the first list of resource sets comprises a first set of PRACH occasions and a first set of preambles, and the second list of resource sets comprises a second set of PRACH occasions and a second set of preambles, and the terminal device comprises circuitry configured to select the first list of resource sets; and the terminal device comprises circuitry configured to perform the repetitions for the at least one PRACH by: performing the repetitions for the at least one PRACH using the first set of PRACH occasions and the first set of preambles; and causing a transmission power of the repetitions to be consistent.

In some embodiments, the terminal device is configured with a normal uplink transmission and a supplementary uplink transmission, and the terminal device comprises circuitry configured to determine whether to perform the normal uplink transmission or the supplementary uplink transmission based on a third power threshold.

In some embodiments, the terminal device comprises circuitry configured to detect downlink control information in a first random access response monitoring window; and perform the repetitions for the at least one PRACH based on a transmission code index (TCI) state associated with the random access response monitoring window.

In some embodiments, the terminal device comprises circuitry configured to detect downlink control information on a control resource set (CORESET), wherein the CORESET indicates a first TCI state; and perform the repetitions for the at least one PRACH based on the first TCI state.

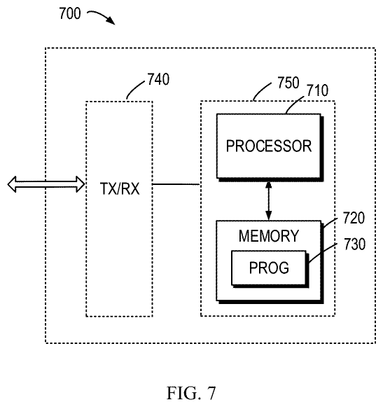

FIG. 7 is a simplified block diagram of a device 700 that is suitable for implementing embodiments of the present disclosure. The device 700 can be considered as a further example implementation of the network device 120, or the terminal device 110 as shown in FIG. 1. Accordingly, the device 700 can be implemented at or as at least a part of the terminal device 110, or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 2 to 6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means adapted to implement various embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 17. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

What is claimed is:

1. A communication method, comprising:
receiving, at a terminal device and from a network device, a first physical random access channel (PRACH) repetition pattern, wherein the first PRACH repetition pattern comprises a first list of resource sets;
if none of power of the resource sets in the first PRACH repetition pattern exceeds a first power threshold, determining whether power of at least one resource set in the first PRACH repetition pattern exceeds a second power threshold; and
performing repetitions for at least one PRACH based on the determination.

2. The method of claim 1, wherein performing the repetitions for the at least one PRACH comprises:
in accordance with a determination that the power of the at least one resource set exceeds the second power threshold, performing the repetitions for the at least one PRACH based on one of the at least one resource set.

3. The method of claim 1, wherein performing the repetitions for the at least one PRACH comprises:
in accordance with a determination that none of power of the resource sets in the first PRACH repetition pattern exceeds the second power threshold, performing the repetitions for the at least one PRACH based on one resource set in the first list of resource sets.

4. The method of claim 1, further comprising:
receiving, from the network device, a second PRACH repetition pattern, wherein the second PRACH repetition pattern comprises a second list of resource sets, and the first list of resource set is associated with a first beam and the second list of resource set is associated with a second beam.

5. The method of claim 4, further comprising:
if none of power of the resource sets in the second PRACH repetition pattern exceeds the first power threshold, determining whether power of at least one resource set in the second PRACH repetition pattern exceeds the second power threshold.

6. The method of claim 5, wherein performing the repetitions for the at least one PRACH comprises:
in accordance with a determination that power of all resource sets in the first PRACH repetition pattern exceed the second power threshold and a determination that power of the at least one resource set in the second PRACH repetition pattern is below the second power threshold,
performing the repetitions for the at least one PRACH on the first beam based on the first PRACH pattern.

7. The method of claim 5, further comprising
in accordance with a determination that power of all resource sets in the first PRACH repetition pattern exceed the second power threshold and a determination that power of all resource sets in the second PRACH repetition pattern exceeds the second power threshold,
performing the repetitions for the at least one PRACH based on one of: the first PRACH repetition pattern or the second PRACH repetition pattern.

8. The method of claim 5, further comprising
in accordance with a determination that the power of the at least one resource set in the first PRACH repetition pattern is below the second power threshold and a determination that the power of the at least one resource set in the second PRACH repetition pattern is below the second power threshold,
performing the repetitions for the at least one PRACH based on one of: the first PRACH repetition pattern or the second PRACH repetition pattern.

9. The method of claim 5, wherein performing the repetitions for the at least one PRACH comprises:
in accordance with a determination that the power of the at least one resource set in the first PRACH repetition pattern exceeds the second power threshold and a determination that none of power of the resource sets in the second PRACH repetition pattern exceeds the second power threshold,
performing the repetitions for the at least one PRACH on the first beam based on the first PRACH pattern.

10. The method of claim 5, further comprising:
in accordance with a determination that the power of the at least one resource set in the first PRACH repetition pattern exceeds the second power threshold and a determination that the power of the at least one resource set in the second PRACH repetition pattern exceeds the second power threshold,
performing the repetitions for the at least one PRACH based on one of: the first PRACH repetition pattern or the second PRACH repetition pattern.

11. The method of claim 5, further comprising:
in accordance with a determination that none of power of the resource sets in the first PRACH repetition pattern exceeds the second power threshold and a determination that none of power of the resource sets in the second PRACH repetition pattern exceeds the second power threshold,
performing the repetitions for the at least one PRACH based on one of: the first PRACH repetition pattern or the second PRACH repetition pattern.

12. The method of claim 5, wherein performing the PRACH repetition comprises:
in accordance with a determination that average power of all resource sets in the first PRACH repetition pattern exceeds the second power threshold and a determination that average power of all resource sets in the second PRACH repetition pattern is below the second power threshold,
performing the repetitions for the at least one PRACH on the first beam based on the first PRACH repetition pattern.

13. The method of claim 5, further comprising:
in accordance with a determination that average power of all resource sets in the first PRACH repetition pattern exceeds the second power threshold and a determination that average power of all resource sets in the second PRACH repetition pattern exceeds the second power threshold, performing the repetitions for the at least one PRACH based on one of: the first PRACH repetition pattern or the second PRACH repetition pattern.

14. The method of claim 5, wherein performing the repetitions for the at least one PRACH on the first beam comprises:
in accordance with a determination that average power of all resource sets in the first PRACH repetition pattern is below the second power threshold and a determination that average power of all resource sets in the second PRACH repetition pattern is below the second power threshold, performing the repetitions for the at least one PRACH based on one of: the first PRACH repetition pattern or the second PRACH repetition pattern.

15. The method of claim 4, wherein the first list of resource sets comprises a first set of PRACH occasions and a first set of preambles, and the second list of resource sets comprises a second set of PRACH occasions and a second set of preambles, and
wherein the method further comprises:
selecting the first list of resource sets; and
wherein performing the repetitions for the at least one PRACH comprises:
performing the repetitions for the at least one PRACH using the first set of PRACH occasions and the first set of preambles; and
causing a transmission power of the repetitions to be consistent.

16. The method of claim 1, wherein the terminal device is configured with a normal uplink transmission and a supplementary uplink transmission, and wherein the method further comprises:
determining whether to perform the normal uplink transmission or the supplementary uplink transmission based on a third power threshold.

17. The method of claim 1, further comprising:
detecting downlink control information in a first random access response monitoring window; and
performing the repetitions for the at least one PRACH based on a transmission code index (TCI) state associated with the random access response monitoring window.

18. The method of claim 1, further comprising:
detecting downlink control information on a control resource set (CORESET), wherein the CORESET indicates a first TCI state; and
performing the repetitions for the at least one PRACH based on the first TCI state.

19. A terminal device comprising:
a processor; and
a memory coupled to the processor and storing instructions thereon, the instructions, when executed by the processor, causing the terminal device to perform the method according to any of claims 1-18.

20. A computer readable medium having instructions stored thereon, the instructions, when executed on at least one processor, causing the at least one processor to perform the method according to any of claims 1-18.
